(19) United States
(12) Patent Application Publication
(10) Pub. No.: US 2008/0300364 A1
(43) Pub. Date: Dec. 4, 2008

(54) Carbon nanotube/polyolefin composite by water-crosslinking reaction and method thereof

(75) Inventors: Hsu-Chiang Kuan, Kaohsiung City (TW); Chen-Feng Kuan, Taichung County (TW); Chia-Hsun Chen, Taichung City (TW); Kun-Chang Lin, Tainan City (TW); Min-Chi Chung, Taichung County (TW); Hsin-Chin Peng, Taichung City (TW)

Correspondence Address: HUDAK, SHUNK & FARINE, CO., L.P.A., 2020 FRONT STREET, SUITE 307, CUYAHOGA FALLS, OH, 44221, US

(73) Assignee: FAR EAST UNIVERSITY, TAINAN CITY (TW)

(21) Appl. No.: 12/011,138

(22) Filed: Jan. 24, 2008

(30) Foreign Application Priority Data
May 28, 2007 (TW) 096119047

(51) Int. Cl. C08F 8/00

(52) U.S. Cl. 525/101

(57) ABSTRACT

A method for preparing a carbon nanotube (CNT)/polyolefin composite by a water-crosslinking reaction and its preparation method are disclosed. Taking an embodiment for example, a carbon nanotube, an organic unsaturated silane and a plastic material are provided, and then the carbon nanotube and the organic unsaturated silane are mixed uniformly by a dispersant. The mixture is bonding with the plastic material by the silicon of organic unsaturated silane. A composite provided with a better combination of carbon nanotube and plastic material is generated by the method of the present invention.

### BACKGROUND OF THE INVENTION

(a) Field of the Invention

The present invention is related to a carbon nanotube (CNT)/polyolefin composite treated by a water-crosslinking reaction and method thereof, and more particularly to the technology filed of mixing the plastic material with the modified CNT prepared by the foregoing method to significantly improve the mechanical properties and electrical properties.

(b) Description of the Prior Art

Plastic products, the organic compounds of polymer applied frequently in our daily life. In general, the plastic materials can be classified into two types, thermoplastic and thermosetting material.

The advantages of plastics include low electric conductivity, light weight, stable chemical properties, durable impact properties, high transparency, wear-resisting, easy shaping and coloring and low cost. However, plastics also has the disadvantages of difficulty in decomposition, low heat-resisting, brittleness at low temperature and deformable beyond burden.

The technique field of products in foreign plastics and machine-driven industries is developed around the following aspects. All sorts of products for the most part develop toward microminiaturization and maximization. For example, there are lots of market requirements obviously at the aspects of electronics, information technology, electric equipment, medical equipment and biotechnology. The application scope of plastics takes extensively aspect, including family appliances, electric products, and automobile parts and building materials. The plastics with superior performances appear gradually, and are further applied to the field of metals, lumbers, fibers, ceramics and even the rocks. There are plenty sorts of materials of plastics and even more than seventy sorts of common plastics. Moreover, performances of different plastics are quite different according to the distinctions such as sorts, forming conditions, design and using conditions. Whatever the high intensity, corrosiveness and penetrability of plastics are, there are lots sorts of plastics provided for the different conditions with different products upon physical properties of materials.

There is no excellence when only one kind of plastic is selected to compare with other materials. The different properties of each plastic can be observed if the whole family of plastics is listed. Although some properties of plastics can not be compared with metals, fibers or glasses and so on, its relative properties are better than the relative properties of other materials. Accordingly, the material of plastic is commonly used to manufacture components in product design.

Polyolefin grafting with silane was achieved by crosslinking with water and followed by the hydrolysis to Si—OH groups and subsequently condensation to form Si—O—Si bonds. This process is through free radical initiators and can subsequently condense through water, leading to the formation of crosslinking. Crosslinking of polyolefin molecules into three-dimensional networks leads to improve nanocomposite properties such as impact strength, chemical resistance, and thermal characteristics.

Carbon nanotubes (CNT) has specific properties, such as low density, high strength, high tenacity, large surface area, high surface curvatures, high thermal conductivity, excellent electronic conductivity and so on, so that the CNT attracts lots of researchers to pay their attention on developing various application, such as the composite material, the microelectronic material, the plane monitor, wireless communication, the fuel cell, a lithium battery and so on. Among these applications, composite materials take the greatest field for the requirement and the application of carbon nanotubes (CNT). For example, CNT added in a plastic material can efficiently enhance mechanical properties, electronic properties, and the EMI protective effect. At the same time, it improves the disadvantage of plastics, such as poor heat-resistant, poor brittleness at low temperature and variability with overstress, for extensively applications.

In order to prepare the carbon nanotube reinforced polyolefin nanocomposite, some efforts have been conducted via in-situ synthesis or simple melt blending. However, the mechanical properties and thermal stability of composites are not good enough to manifest the reinforcement of carbon nanotube if the composites were prepared by either in-situ synthesis or simple melt blending, since the aggregation of CNT limits the fully utilization of CNT. The homogeneous dispersion of CNT in the host matrix and the interfacial interaction between filler and matrix are the key points to achieve better CNT nanocomposites.

In view of the drawbacks of the prior art, the inventor of the present invention based on years of experience in the related industry to conduct extensive researches and experiments, and finally developed a carbon nanotube (CNT)/polyolefin composite by a water-crosslinking reaction and method thereof in accordance with the present invention to overcome the aforementioned drawbacks.

### SUMMARY OF THE INVENTION

The primary purpose of the present invention is to provide a carbon nanotube/polyolefin composite by a water-crosslinking reaction and method thereof, and the electronic property and mechanical property of plastic materials combined with CNT are promoted by the superior physical property, chemical property and material property.

To achieve the purpose, a CNT/polyolefin composite by a water-crosslinking reaction includes a plastic material, a CNT and an organic unsaturated silane.

Furthermore, the present invention discloses a method to prepare a carbon nanotube (CNT)/polyolefin composite by a water-crosslinking reaction involving the following steps of:

a). providing a plastic material, a CNT and an organic unsaturated silane;

b). dispersing the organic unsaturated silane by a dispersant to mix the organic unsaturated silane with the CNT uniformly; and

c). processing a water-crosslinking reaction with the mixture made from step (b) and the plastic material to lead to the CNT and the plastic material to form a Si—O—Si bonding by way of silicon of the organic unsaturated silane.

In addition, the composite material of the present invention is synthesized by the process of precision intermixing, granulating, processing and molding, and it further includes a fiber filler or inorganic filler, and fire retardant such as Mg(OH)₂, Al(OH)₃, phosphorous compound or nitrogen compound.

To make it easier for our examiner to understand the objective of the invention, its structure, innovative features, and performance, we use preferred embodiments together with the attached drawings for the detailed description of the invention.

### BRIEF DESCRIPTION OF THE DRAWINGS

FIG. 1 is a process flow diagram of method of preparing a carbon nanotube (CNT)/polyolefin composite by a water-crosslinking reaction of the present invention;

FIG. 2 is a chemical structural formula schematic view showing plastic material and CNT grafted with silane individually and then via water-crosslinking reaction;

FIG. 3 is a mechanical property and heat deflection temperature comparison table showing the LLDPE grafted with silane, unmodified CNT and modified CNT separately after via water-crosslinking reaction; and

FIG. 4 is a mechanical property and heat deflection temperature comparison table showing the CNT mixed with the LLDPE and coupling agent directly via water-crosslinking reaction, and the LLDPE grafted with coupling agent first and then via water-crosslinking reaction.

### DETAILED DESCRIPTION OF THE PREFERRED EMBODIMENTS

In the related figures of a preferred embodiment, the same referring numerals are used for the same components of an input apparatus in accordance with the present invention.

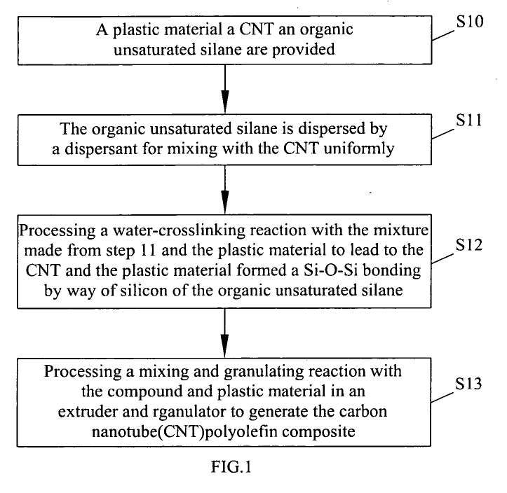

As illustrated in FIG. 1 for a process flow chart of method to prepare a CNT/polyolefin composite by a water-crosslinking reaction of the present invention, the method thereof is involving the following steps of:

Step S10: providing a plastic material, a CNT and an organic unsaturated silane;

Among them, the plastic material may be one of the polymer, copolymer, derivative or mixture of ethylene and propylene. The polymer includes at least polyethylene, polypropylene, polymer of ethylene and α-olefine, copolymer of ethylene and acetic ether, copolymer of ethylene and acrylic acid, copolymer of ethylene and methyl-methacrylate, or the mixture thereof.

The organic unsaturated silane may be ethyltrimethoxylsilane, ethyltrimethylethylsilane, ethyl-butoxylsilane, propyltrimethoxylsilane, propyltriethoxylsilane or the mixture thereof.

The CNT includes unmodified or modified of single-walled carbon nanotubes, multi-walled carbon nanotubes, carbon nanoballs or carbon nanofibers. The modified CNT includes the CNT and the organic group coincided to the surface of the CNT. This organic group includes an unsaturated monomer which is related to the residue remained from an organic unsaturated silane having a covalent bond with the CNT activated by a free-radical initiator.

Step S11: dispersing the organic unsaturated silane by using a dispersant to mix the organic unsaturated silane with the CNT uniformly;

In the preferred embodiment, the dispersant may be embodied with an acetone. 2 phr the coupling agent, vinyltrimethoxyl silane (VTMOS) is added to the CNT in the acetone solution, and then the moisture of the solution is dehydrated at the same time by a Henschel Mixer. The functional groups of coupling agent will lose the function when it is easily reacted with water. So most water of the CNT has to be dehydrated in advance, and then the acetone solution with coupling agent is added.

Besides, the reaction initiator at step 11 includes dicumyl peroxide, α-α-xylene, 2,5-dimethyl-2,5-dihexane, dibenzoxyl peroxide, dicumyl peroxide, 2-terbutylperoxide, terbutylcumyl peroxide, peroxyterbutyltervalerate or peroxy-2-ethylterbutylcaproate.

Alternatively, the organic metal compound illustrated at step 11 can be taken as a catalyst, and the organic metal compound includes dibutyltin dilaurate, dibutyltin diacetate, dibutyltin dicaprylate, stannous acetate, tetrabutyl titanate, lead naphthoate, zinc caprylate, calcium stearate, lead stearate, or cadmium stearate.

Step S12: Processing a water-crosslinking reaction with the mixture made from step 11 and the plastic material to lead the CNT and the plastic material to form a Si—O—Si bonding by way of silicon of the organic unsaturated silane.

Step S13: Processing a mixing and granulating reaction with the compound and plastic material in an extruder and granulator to generate the carbon nanotube (CNT)/polyolefin composite by a water-crosslinking reaction.

Proper proportion of CNT treated with coupling agent and treated without coupling agent individually are mixed with the plastic material in the Banbury mixer. A granulating reaction is performed in the Banbury palletizer after the mixing is completed. Then the extruder is prepared to proceed the injected specimen of ASTM shaped specimen, thereby testing physical properties.

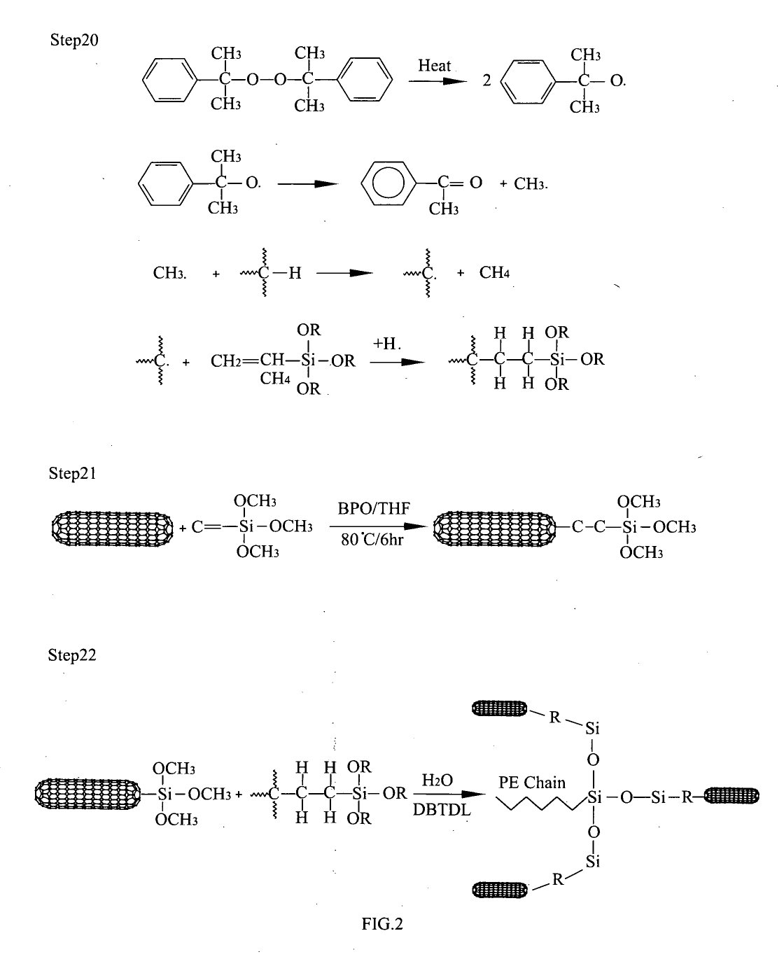

Please referring to FIG. 2 for a chemical structural formula schematic view showing plastic material and CNT grafted with silane individually and then via water-crosslinking reaction. The plastic material is embodied with a linear low density polyethylene (thereinafter is called LLDPE) and the organic unsaturated silane is embodied with a dicumyl peroxide (DCP) coupling agent, ethyltrimethoxyl silane.

As illustrated in the first structural formula of step 20 for a polyethylene molecular is heated and decomposed two monomers having free radical.

As illustrated in the second structural formula of step 20 for a monomer is processed with condensation reaction to release a methyl group.

As illustrated in the third structural formula of step 20, the monomer is reacted with the methyl group and the electron of methyl group is transferred to lead the monomer to have a free radical for reaction.

As illustrated in the fourth structural formula of step 20, the free radical of the monomer is grafted with a coupling agent, the ethyltrimethoxyl silane, to gain a product concerning to the polyethylene compound grafted with the coupling agent, ethyltrimethoxyl silane.

Then, as illustrated in step 21 of FIG. 2 for the structural formula that a CNT is grafted with a coupling agent, ethyltrimethoxyl silane.

Next, as illustrated in step 22 of FIG. 2 for the structural formula of a CNT grafted with coupling agent and a product, which is via a water-crosslinking reaction, concerning to polyethylene grafted with coupling agent.

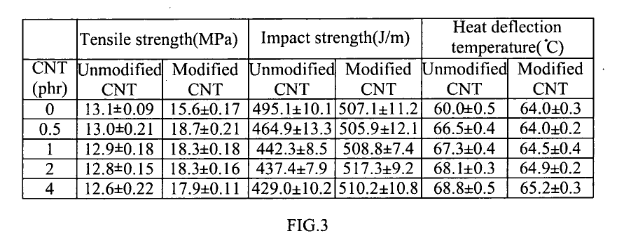

Please referring to FIG. 3 for a mechanical property and heat deflection temperature comparison table showing the LLDPE grafted with silane, and treated with unmodified CNT and modified CNT separately in different proportion. Owing to the weaker interfacial intensity between unmodified CNT and LLDPE, the gathering of CNT decreases in tensile strength as the contents of CNT increase. The tensile strength of CNT/LLDPE nanocomposites treated with 4 phr unmodified CNT decreases from 13.1 MPa to 12.6 MPa.

While 0.5 phr CNT, which is treated with 2 phr vinyltrimethoxysilane (VTMOS), and an initiator, which is preferred to be dicumyl peroxide (DCP), is grafted to the main chain of LLDPE via twin-screw melting reaction, the tensile strength is increased from 13.1 MPa to 18.7 MPa. However, 0.5 phr CNT grafted with VTMOS (VTMOS-g-MWCNT) is then mixed with VTMOS-g-LLDPE via twin-screw melting reaction, the tensile strength thereof further promotes up to 19.0 MPa (increasing by 45%). The result reveals that a stronger bonding exists in the interface between the CNT modified by VTMOS and LLDPE, hence, the tensile strength of nanocomposites modified is stronger than that of nanocomposites unmodified.

According to the impact strength of MWCNT/LLDPE nanocomposite, the impact strength trends toward decreasing as the contents of unmodified MWCNT are increased. While the composite is treated with 0.5 phr unmodified CNT, the impact strength of the composite decreases from 495.1 J/m to 464.9 J/m. However the MWCNT treated with VTMOS is provided with a stronger interfacial intensity, and the impact strength thereof further promotes up to 505.9 J/m. Of the system of VTMOS-g-MWCNT and VTMOS-g-MWCNT, the impact strength of MWCNT/LLDPE with the same quantity contained 5 phr further promotes up to 520.1 MPa.

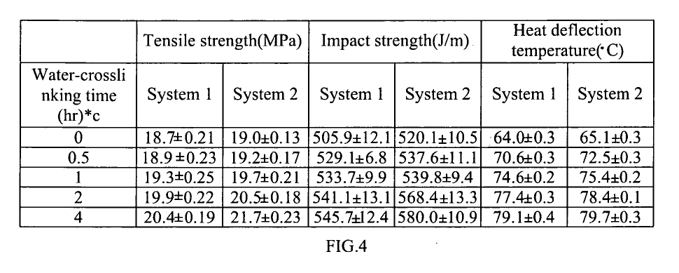

Please referring to the FIG. 4 for a mechanical property and heat deflection temperature comparison table showing the CNT mixed with the LLDPE and coupling agent directly via water-crosslinking reaction, and the LLDPE grafted with coupling agent first and then via water-crosslinking reaction. Wherein the system 1 represents unmodified multi-walled CNT mixed with LLDPE and silane directly via water-crosslinking reaction. The system 2 represents modified multi-walled CNT mixed with LLDPE which is grafted with silane via water-crosslinking reaction.

After the MWCNT/LLDPE nanocomposite is processed via water-crosslinking reaction for different time (0 hr, 0.5 hr, 1 hr, 2 hrs and 4 hrs) at 70° C., the tensile strength of the nanocomposite treated with modified CNT is obviously stronger than the tensile strength of the nanocomposite treated with unmodified CNT. While the MWCNT/LLDPE nanocomposite contained 0.5 phr modified CNT is processed via water-crosslinking reaction processes for 4 hours, the tensile strength of the nanocomposite increases from 19.0 MPa to 21.7 MPa (increasing by 14.2%). The result reveals that there is good interfacial compatibility between modified CNT and LLDPE, so that CNT is dispersed in the plastic material, LLDPE. In other words, the network structure —Si—O—Si— generated after water-crosslinking reaction can efficiently enhance the physical properties of the nanocomposite. This reason the tensile strength of the nanocomposite increases as the time of crosslinking with water increases. However, in the MWCNT/LLDPE nanocomposite of system 2, the impact strength thereof increases as time of the crosslinking with water increases. The impact strength promotes to 580.0 J/m after water-crosslinking reaction for 4 hours, because the softer network structure —CH₂—CH₂—Si—O—Si— is generated to toughen the MWCNT/LLDPE nanocomposite between MWCNT and LLDPE via water-crosslinking reaction.

The heat deflection temperature of unmodified MWCNT/LLDPE nanocomposite increases as the contents of the MWCNT increases. It increases from 60.0° C. to 68.8° C. while the nanocomposite is treated with 4 phr unmodified MWCNT. However the heat deflection temperature of the MWCNT/LLDPE nanocomposite treated with VTMOS trends toward decreasing slightly, it is because that the VTMOS is only grafted to the main chain of the nanocomposite but not accessed a Sol-Gel crosslinking reaction with water. For this reason, the additional chain makes effects on the decrease of heat deflection temperature of the nanocomposite. The heat deflection temperature of the system of VTMOS-g-MWCNT and VTMOS-g-LLDPE for 0.5 phr goes up as time of water-crosslinking reaction increases. After 4 hours of crosslinking with water, the network structure and interfacial compatibility make effects on the heat deflection temperature promoted from 60.0° C. to 79.7° C. (more than LLDPE by 32.8%).

DCP is taken as an initiator to process a melting reaction that the VTMOS is grafted to the main chain of LLDPE, it may bring about lots of side reactions such as the crosslinking and grafting reaction of PE itself. It is more important about how to prove that the physical properties promoted via water-crosslinking reaction are not only contributed by water-crosslinking reaction.

As shown in FIG. 4, LLDPE grafting with silane via water-crosslinking reaction is achieved by reacted via free radical for the ethylsilane grafted to the main chain of LLDPE, and then followed by the Sol-gel condensation crosslinking with water, which promotes the physical properties of LLDPE. Hence, the tensile strength can be efficiently increased by 18.5% via water-crosslinking reaction for 4 hours. However, the present embodiment emphasizes that the MWCNT/LLDPE nanocomposite via crosslinking with water is generated with 0.5 phr VTMOS-g-MWCNT and VTMOS-g-LLDPE, and the tensile strength of the nanocomposite is promoted by a wide margin by 65.6% from 13.1 MPa to 21.7. MPa. As a result, the promotion of physical properties is contributed not only by crosslinking with water but also greatly by the system of the MWCNT treated with VTMOS (VTMOS-g-MWCNT).

Thus it can be seen by the embodiment, if the plastic material is treated with the unmodified CNT, the CNT can not be dispersed well out of the aggregation of CNT, but the tensile strength and impact strength decrease instead. Owing to the extremely expensive price of CNT, the rise in heat deflection temperature is not corresponding to the economic benefits and not enough to actual apply on commercial purpose. On the contrary, if the plastic material is treated with modified CNT, the tensile strength and impact strength can be promoted efficiently as a result of the well dispersion of the modified CNT. The network structure —Si—O—Si— generated by crosslinking with water efficiently reinforces the physical properties of the composite. So the tensile strength increases as the time of crosslinking with water increases, and the heat deflection temperature promotes greatly by a wide margin via water-crosslinking reaction.

In the above-mentioned composites, the proportion of CNT prefers between 0.1 wt % and 20 wt %.

It is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

What is claimed is:

1. A carbon nanotube (CNT)/polyolefin composite by a water-crosslinking reaction, comprising:
(a) a plastic material;
(b) carbon nanotubes; and
(c) a organic unsaturated silane.

2. The carbon nanotube (CNT)/polyolefin composite by a water-crosslinking reaction of claim 1, wherein said plastic material is related to polyethylene, polypropylene, polymer of ethylene and α-olefine, copolymer of ethylene and acetic ether, copolymer of ethylene and acrylic acid, copolymer of ethylene and methyl-methacrylate, or the mixture thereof.

3. The carbon nanotube (CNT)/polyolefin composite by a water-crosslinking reaction of claim 1, wherein said carbon nanotubes are related to modified or unmodified of single-walled or multi-walled of carbon nanotubes, carbon nanoballs and carbon nanofibers.

4. The carbon nanotube (CNT)/polyolefin composite by a water-crosslinking reaction of claim 1, wherein said organic unsaturated silane is related to ethyltrimethoxyl silane, ethyltrimethylethyl silane, ethyl-butoxyl silane, propyltrimethoxy I silane, propyltriethoxyl silane or the mixture thereof.

5. The carbon nanotube (CNT)/polyolefin composite by a water-crosslinking reaction of claim 1, wherein further comprising polyolefin grafted with organic acid.

6. The carbon nanotube (CNT)/polyolefin composite by a water-crosslinking reaction of claim 3, wherein said modified carbon nanotubes, nanoballs or nanofibers include carbon nanotubes and the organic group coincided to the surface of said carbon nanotubes.

7. The carbon nanotube (CNT)/polyolefin composite by a water-crosslinking reaction of claim 4, wherein said polyolefin grafted organic acid is related to PE-g-AA, PE-g-MA, PP-g-MA or EVA-g-MA.

8. The carbon nanotube (CNT)/polyolefin composite by a water-crosslinking reaction of claim 7, wherein said organic group is related to a unsaturated monomer which is related to the residue remained from an organic unsaturated silane having a covalent bond with the CNT activated by a free-radical initiator.

9. A method for synthesis the MWCNT/LLDPE nanocomposite via water-crosslinking reaction comprising the steps of:
(a) providing a plastic material, carbon nanotubes and a organic unsaturated silane;
(b) dispersing the organic unsaturated silane by using a dispersant for mixing with the CNT; and
(c) Processing a water-crosslinking reaction with the mixture made from said step (b) and said plastic material to lead to said CNT and said plastic material to form a Si—O—Si bonding by way of silicon of said organic unsaturated silane.

10. The method of claim 9, wherein said dispersant is related to the acetone.

11. The method of claim 9, wherein the reaction time of crosslink with water in said step (b) is 4 hours.

12. The method of claim 9, wherein the temperature of water-crosslinking reaction of said step b is 70° C.

13. The method of claim 9, wherein said step (b) further comprises a step of adding a reaction initiator which is related to dicumyl peroxide, α-α-xylene, 2,5-dimethyl-2,5-dihexane, dibenzoxyl peroxide, dicumyl peroxide, 2-terbutylperoxide, terbutylcumyl peroxide, peroxyterbutyltervalerate or peroxy-2-ethylterbutylcaproate.

14. The method of claim 9, wherein the organic metal compound applied in said step b is a catalyst.

15. The method of claim 14, wherein said catalyst is related to dibutyltin dilaurate, dibutyltin diacetate, dibutyltin dicaprylate, stannous acetate, tetrabutyltitanate, lead naphthoate, zinc caprylate, calcium stearate, lead stearate, cadmium stearate.

16. The carbon nanotube (CNT)/polyolefin composite by a water-crosslinking reaction of claim 1, further comprising fiber filler, inorganic filler or fire retardant such as Mg(OH)₂, Al(OH)₃, phosphorous compound or nitrogen compound.

17. The carbon nanotube (CNT)/polyolefin composite by a water-crosslinking reaction of claim 1, wherein the proportion of said CNT prefers between 0.1 wt % and 20 wt %.
